(19) United States
(12) Patent Application Publication
(10) Pub. No.: US 2007/0131504 A1
(43) Pub. Date: Jun. 14, 2007

(54) Planar vibration absorber

(75) Inventors: Allen J. Bronowicki, Laguna Niguel, CA (US); Sarah M. Brennan, Manhattan Beach, CA (US); Stepan S. Simonian, Torrance, CA (US)

Correspondence Address: Carmen B. Patti, Esq.;Carmen B. Patti & Associates, LLC, 4th Floor, One North LaSalle Street, Chicago, IL, 60602, US

(73) Assignee: Northrop Grumman Corporation

(21) Appl. No.: 11/304,018

(22) Filed: Dec. 14, 2005

(51) Int. Cl. F16F 7/10

(52) U.S. Cl. 188/378; 188/379

(57) ABSTRACT

A tuned mass damper for attenuating vibrations in a selected plane of a mechanical structure, by magnetically induced eddy current damping. A moving damper mass is coupled to a vibrating mass through one or more flexures that confine relative movement of the damper mass substantially to the selected plane. A magnet structure is rigidly attached to either the vibrating mass or the damper mass, and a conductor plate is attached to the other of these masses. Movement of the damper mass relative to the vibrating mass induces eddy currents in the conductor plate and thereby generates a damping force that attenuates vibration in the selected plane.

### BACKGROUND OF THE INVENTION

This invention relates generally to vibration damping mechanisms and, more particularly, to techniques for damping vibrations that may occur within a geometric plane of a mechanical structure. Mechanical structures of all kinds are subject to unwanted vibrations. Of particular interest are structures that are intended to provide an extremely stable platform for precision equipment, such as space-based telescopes. Vibrations may be due to related motors and other equipment. Without damping, vibrations may resonate with structural members and render the equipment inoperative or, at worst, may cause damage to the structure or its supported equipment.

Ideally, damping should be achieved inertially without introducing a damper into a load path associated with the damped structure, which may distort a critical aspect of damped structure. The damping mechanism should preferably provide damping effectiveness in multiple directions, such as a single plane, should operate over a wide range of vibration amplitudes and, for use in space applications, should be operable over a wide range of temperatures, including cryogenic temperatures. The present invention meets and exceeds these requirements.

### SUMMARY OF THE INVENTION

The present invention resides in a planar vibration damping mechanism. Briefly, and in general terms, the present invention may be defined as a tuned mass damper for attenuating vibration of a mechanical structure in a selected plane, the damper comprising a frame for attachment to a vibrating mass; a movable damper mass; flexure means for connecting the movable damper mass to the frame to confine movement of the damper mass substantially to the selected plane; a magnet structure having at least two magnetic poles and arranged to generate a magnetic field across a gap in the magnet structure; and a conductor plate positioned for free movement within the gap in the magnet structure. The magnet structure is mechanically attached to either the frame or the damper mass, and the conductor plate is mechanically attached to the other of either the frame or the damper mass. Vibration of the frame is transferred to the damper mass through the flexure means, and is attenuated by generation of eddy currents and a resultant damping force on the conductor plate.

Several different embodiments of the invention are possible. In one embodiment, the magnet structure is part of the damper mass and the conductor plate is attached to the frame, which of course is attached to the vibrating mass. In another embodiment, the magnet structure is attached to the frame and the conductor plate is attached to the damper mass. Ideally, the magnet structure comprises four magnetic pole pairs arranged in a symmetrical configuration, since use of fewer di-pole magnets does not provide equal damping force in both orthogonal directions in the selected plane.

The flexure means in one group of embodiments comprises a plurality of elongated flexures extending in a parallel post-like arrangement from the frame to the magnet structure. Movement of the magnet structure mounted on these flexures is substantially confined to a plane perpendicular to the flexures. In a variant of this arrangement, the flexure means comprises a single elongated flexure extending from the frame to the magnet structure. Movement of the magnet structure relative to the frame is, for small excursions, substantially confined to a plane perpendicular to the single elongated flexure.

In another embodiment of the invention, the flexure means comprises multiple L-shaped flexures arranged in a coplanar configuration. Each flexure is attached by one of its ends to the frame and by its other end to the damper mass. The flexures are designed to provide substantially identical stiffness properties with respect to both orthogonal directions in the coplanar arrangement and they function to confine movement of the damper mass to the selected plane.

Another feature of the tuned mass damper is the inclusion of means to limit movement of the damper mass with respect to the frame. When elongated flexures are employed, this limiting means comprises multiple bumpers mounted inside the frame or on frame members extending about the flexures. In the embodiment employing L-shaped flexures, the means for limiting damping mass movement comprises multiple snubber assemblies. Each snubber assembly includes a pin affixed to either the frame or the damper mass, and a loosely fitting bushing fixed to the other one of the frame or the damper mass. The bushing is lined with a resilient material, which is contacted by the pin to limit lateral movement of the damper mass relative to the frame.

It will be appreciated from the foregoing summary that the present invention represents a significant advance in the field of vibration damping of mechanical structures. In particular, the invention provides a tuned mass damper that attenuates selected vibration modes in all directions within a selected plane of a vibrating mass. Other aspects and advantages of the invention will become apparent from the following more detailed description, taken in conjunction with the accompanying drawings.

### BRIEF DESCRIPTION OF THE DRAWINGS

FIG. 1 is a diagrammatic side view of a first embodiment of the invention.

FIG. 2 is a diagrammatic side view of a second embodiment of the invention.

FIG. 3 is a diagrammatic side view of an embodiment of the invention similar to the embodiment of FIG. 2.

FIG. 4 is a diagrammatic top view of the embodiment of FIG. 3.

FIG. 5 is a diagrammatic side view of an alternate embodiment similar to that of FIGS. 3 and 4, but employing a single elongated flexure instead of multiple flexures to couple a damper mass to vibrating frame.

FIG. 6 is a view similar to FIG. 5, but depicting an alternate bumper arrangement to limit movement of the damper mass.

FIG. 7 is a fragmentary side view depicting yet another bumper arrangement for the single flexure embodiment of FIGS. 5 and 6.

FIG. 8 is a diagrammatic top view of yet another embodiment of the invention, employing L-shaped flexures instead of elongated flexures.

FIG. 9 is an enlarged cross-sectional view of a snubber assembly used in the FIG. 8 embodiment to limit movement of the damper mass relative to the vibrating frame.

### DETAILED DESCRIPTION OF THE INVENTION

As shown in the drawings for purposes of illustration, the present invention pertains to tuned mass damping mechanisms that provide for damping of mechanical vibrations in multiple directions in a single plane. In accordance with the invention, a moving damper mass is coupled to a vibrating mass through one or more flexures designed to permit movement of the damper mass in a selected plane. The one or more flexures are tuned to a known vibration mode of the vibrating mass. The damper further includes a mechanism to damp movement of the moving damper mass with respect to the vibrating mass, as will become clear from the following more detailed description of the several embodiments of the invention.

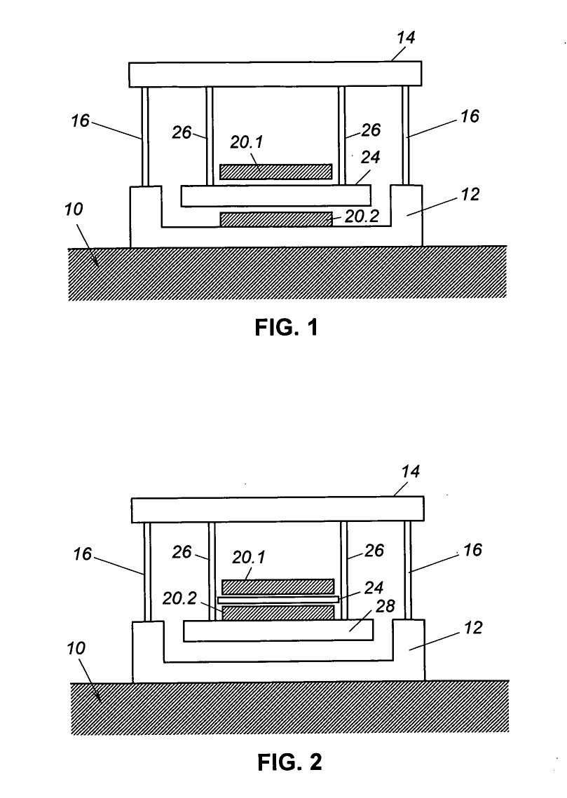

FIGS. 1 and 2 are diagrammatic views depicting two principal embodiments of the invention. In FIG. 1, a vibrating mass of a structure is indicated by reference numeral 10. The damping mechanism of the invention includes a frame member 12 rigidly attached to the vibrating mass 10, and a movable, conductive damper mass 24 supported in the frame member 12 by a plurality of flexures 16 attached to an intermediate structure 14 and a second plurality of flexures 26. Damping is provided by a permanent magnet 20 having upper and lower components 20.1 and 20.2. In this embodiment, the magnet 20 is rigidly coupled to the frame member 12, and therefore moves with the vibrating mass 10. The magnet components 20.1 and 20.2 have a narrow gap between them, through which a magnetic field passes in opposite directions at different areas of the magnet components. Positioned within the gap is the conductor plate 24. Movement of the vibrating mass 10 is, therefore, transferred through the flexures 16 and 26 to the movable damper mass 24, The flexures 16 and 26 are the same length so that as they bend their vertical components of motion cancel, producing a purely in-plane motion.

Following well known electromagnetic principles, movement of the conductive plate 24 through and perpendicular to the magnetic field set up between the magnet components 20.1 and 20.2 generates electrical current in the plate, proportional to the velocity and the magnetic flux density. If the magnetic flux passes through the plate 24 in opposite directions at spatially separated areas of the plate 24, the induced currents are in opposite directions and form continuous loops in the plate. These loop currents are referred to as eddy currents. It is also well known that eddy currents generate a force that opposes the current-inducing force, and that the opposing force is in a direction that opposes the original conductor motion that resulted in the generation of current. That is to say, the force generated is a damping force. More specifically, the current, i, generated by movement of a conductor at velocity, v, through a magnetic field of flux density, B, is given by the proportionality:

$$i ∝ \frac{v \times B}{ρ} ,$$

where ρ is the resistivity of the conductor plate 24.

The force, F, generated by the induced currents is determined by integrating the product of current and magnetic flux density:

$$F = {\int }_{v} i \times B ∝ {\int }_{v} \frac{v \times B \times B}{ρ} .$$

In the embodiment depicted in FIG. 1, the magnets 20.1 and 20.2 are mechanically attached to the vibrating structure 10, through the frame member 12, and the conductor plate/moving mass 24 is suspended on the flexure arrangement 16/14/24. The embodiment depicted in FIG. 2 differs from that of FIG. 1 in that the FIG. 2 magnet structure 20 is the moving mass of the damper. A member 28 supports the magnet structure 20 and is suspended by the flexures 26 from the intermediate structure 14. The conductor plate 24 in the FIG. 2 embodiment is mechanically connected to vibrating mass 10, through a connective structure that is omitted for clarity in the figure. Therefore, in the FIG. 2 embodiment the magnet structure 20 is also the moving mass of the damper, and the conductor plate 24 is mechanically connected to the vibrating mass 10. As in the FIG. 1 embodiment, the flexures 16 and 26 are the same length so that as they bend their vertical components of motion cancel, producing a purely in-plane motion.

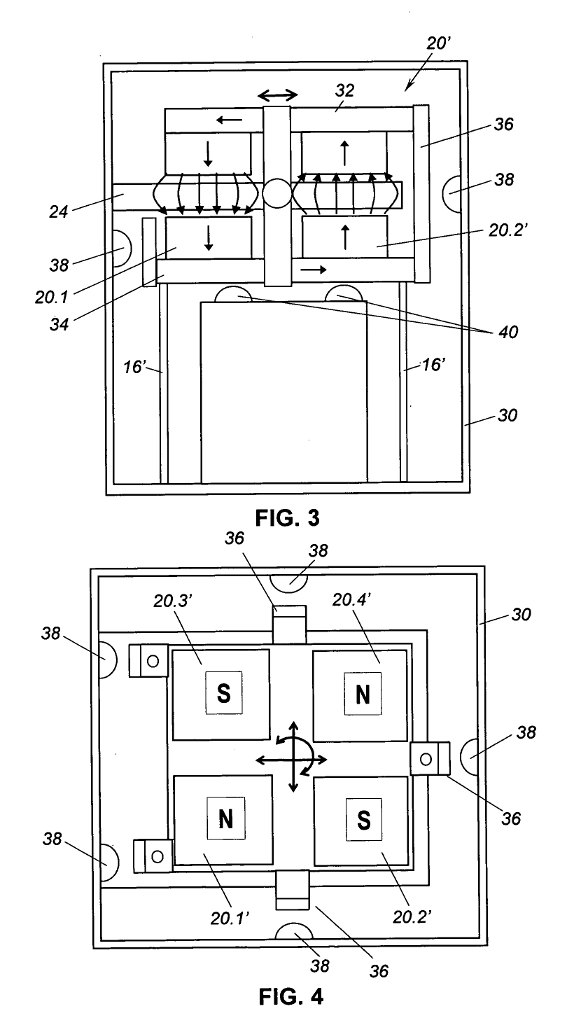

A related embodiment of the invention is depicted in FIGS. 3 and 4. In this embodiment, the vibrating mass 10 (not shown in FIGS. 3 and 4) is rigidly connected to a damper frame 30, to which the conductor plate 24 is rigidly attached. Supported in the frame 30 is a magnet structure 20′. In this embodiment, the magnet structure includes four magnet pole pairs, indicated at 20.1′, 20.2′, 20.3′ and 20.4′ and arranged in a square configuration as indicated by the top view of FIG. 4. The magnet structure 20′ also includes upper and lower plates 32 and 34 of magnetically permeable material, and brackets 36 of non-magnetic material connecting the upper and lower plates. The magnet structure 20′, which also constitutes the moving damper mass, is supported in the frame 30 on multiple flexures 16′, which allow movement of the structure 20′ in the plane of the conductor plate 24, thus transferring in-plane movement of the vibrating mass 10 to the moving damper mass. The frame 30 has multiple stops or bumpers 38 mounted inside the frame to limit movement of the magnet structure 20′ within the frame. Additional stops 40 may also be mounted beneath the lower plate 34 to limit any excessive downward excursion of the magnet structure 20′ in the event of axial buckling of the flexures 16.

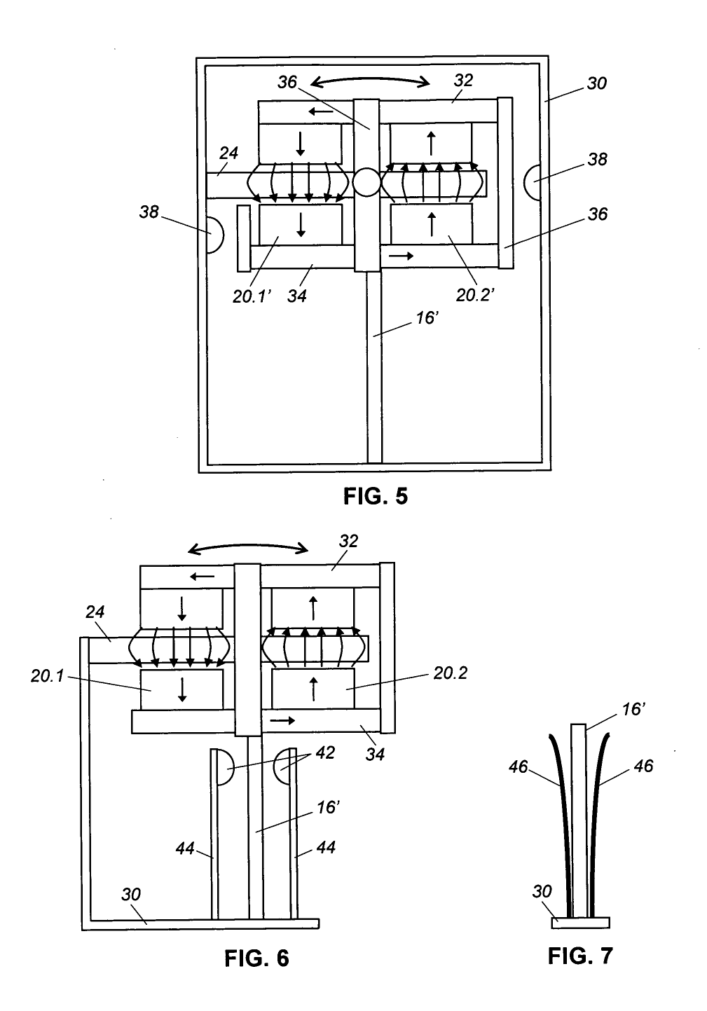

FIGS. 5, 6 and 7 depict a variation of the embodiment of FIGS. 3 and 4, in which the multiple flexures 16′ are replaced by a single flexure 16′ that is centrally located to support the magnet structure 20′. In the configuration of FIG. 5, bumpers 38 are located on the inside walls of the frame 30, in much the same way as in FIG. 3. In the configuration of FIG. 6, bumpers 42 are located on upwardly extending legs 44 beneath the structure 20′. The frame 30 in this embodiment need not extend around both sides of the magnet structure 20′, but simply includes a base member and an upwardly extending portion that attaches to the conductor plate 24. In another variant of the bumper arrangement, FIG. 7 depicts bumpers 46 in the form of curved leaf springs that extend up from the base of the frame 30, adjacent to the single flexure 16′. A disadvantage of using a single flexure 16′ is that additional clearance is required for movement of the conductor plate 24 because motion of the moving damper mass follows a curved, rather than planar path. For small excursions, however, the damper mass moves substantially in the desired plane.

The tuned mass damper of the invention is mounted to a structure whose vibrations are intended to be damped. Large vibrations may result in lateral or axial buckling of the flexures 16, which is why the various bumpers 38, 40, 42 and 46 are required to limit lateral movement of the damper mass. The bumpers may be of suitable elastomeric material to reduce possible shock loads and ensure that the flexure stresses remain within acceptable limits. While motion of the damper mass remains within the limits set by the bumpers, i.e., within the “rattle space” set by the bumpers, the damper functions in a substantially linear manner. For potentially larger excursions of the damper mass, the damper functions in a non-linear manner, as an impact damper. The clearances in the damper are set by the deflections under gravity in which the device must be tested. This practically limits the device to have a resonance set at about 4-5 Hz or above. The damper can operate as a tuned device with relatively low damping designed to target a limited set of modes around the resonance of the device. Or by setting the device at a low frequency with high damping it can operate as an inertial damper to any modes having a frequency higher than the resonance of the device.

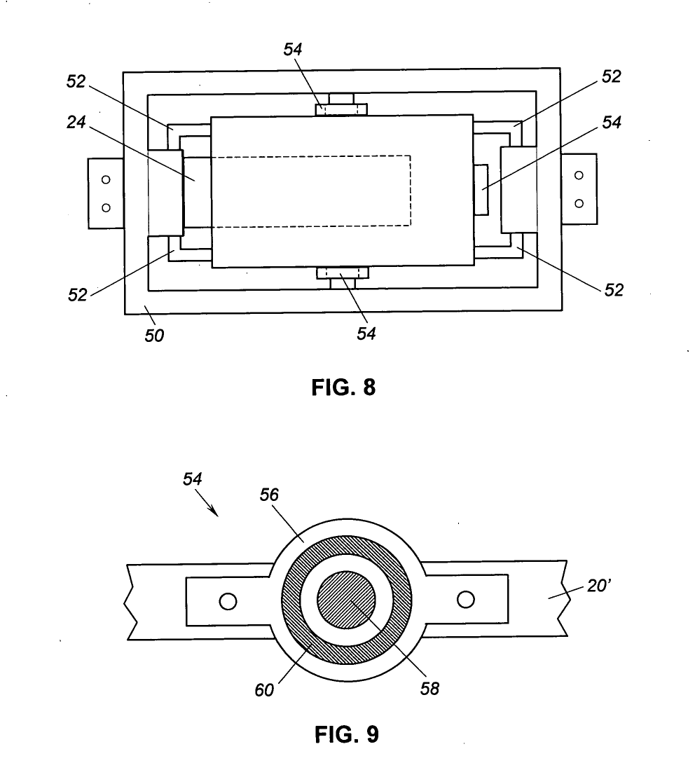

Yet another embodiment of the invention is depicted in FIG. 8. In this embodiment, the conductor plate 24 is again mechanically connected to the vibrating mass 10 (not shown in this figure), through a generally rectangular frame 50. A magnet structure 20′, which can be similar to the structure of FIGS. 3 and 4, with four magnetic pole pairs, is suspended in the frame 50 by four L-shaped flexures 52. These flexures 52 allow movement in any direction within the plane of the conductor plate 24. Each flexure 52 is designed to have the same stiffness in two orthogonal directions in a plane parallel to the conductor plate 24, thus allowing relatively free movement of the magnet structure 20′ in this plane. The flexures 52 are relatively flexible in the common plane in which the flexures are positioned, but are stiff in any out-of-plane direction. Use of the L-shaped flexures 52 rather than four parallel, post-like flexures renders the entire structure much more compact. Multiple (three or four) cylindrical snubbers 54 are used to limit movement of the magnetic structure 20′ within its plane of movement. As depicted in FIG. 9, each snubber 54 includes a metal cylindrical bushing 56 attached to the magnet structure 20′, and a pin 58 attached to the frame 50 and positioned in the center of the metal bushing 56. A rubber (or similar material) bushing 60 lines the metal bushing 56 and limits movement of the pin 58.

It will be appreciated from the foregoing that the present invention represents a significant advance in the field of vibration suppression using tuned mass dampers. In particular, the invention provides a tuned mass damper for suppression of vibration in multiple directions in a given plane of a vibrating mass. Multiple tuned mass dampers of this type may be employed to control anticipated vibrations in various members of a mechanical structure. It will also be appreciated that, although several embodiments of the invention have been depicted and described by way of illustration, various modifications may be made without departing from the spirit and scope of the invention. Accordingly, the invention should not be limited except as by the appended claims.

1. A tuned mass damper for attenuating vibration of a mechanical structure in a selected plane, the damper comprising:
a frame for attachment to a vibrating mass;
a movable damper mass;
flexure means for connecting the movable damper mass to the frame to confine movement of the damper mass substantially to a selected plane;
a magnet structure having at least two magnetic poles and arranged to generate a magnetic field across a gap in the magnet structure, wherein the magnet structure is mechanically attached to one of the frame and the damper mass; and
a conductor plate attached to the other of the frame and the damper mass, and positioned for free movement within the gap in the magnet structure;
wherein vibration of the frame is transferred to the damper mass through the flexure means, and is attenuated by generation of eddy currents and a resultant damping force in the conductor plate.

2. A tuned mass damper as defined in claim 1, wherein:
the magnet structure comprises four magnetic pole pairs arranged in a symmetrical configuration.

3. A tuned mass damper as defined in claim 1, wherein:
the magnet structure is attached to the frame; and
the conductor plate is attached to the damper mass.

4. A tuned mass damper as defined in claim 1, wherein:
the magnet structure is attached to and part of the damper mass; and
the conductor plate is attached to the frame.

5. A tuned mass damper as defined in claim 4, and further comprising:
a plurality of mechanical bumpers mounted on the frame to limit movement of the damper mass.

6. A tuned mass damper as defined in claim 4, wherein:
the flexure means comprises a plurality of elongated flexures extending in parallel from the frame to the magnet structure, whereby movement of the magnet structure relative to the frame is substantially confined to a plane perpendicular to the elongated flexures.

7. A tuned mass damper as defined in claim 4, wherein:
the flexure means comprises a single elongated flexure extending from the frame to the magnet structure, whereby movement of the magnet structure relative to the frame is, for small excursions, substantially confined to a plane perpendicular to the elongated flexure.

8. A tuned mass damper as defined in claim 7, and further comprising:
a plurality of bumpers positioned to limit movement of the damper mass.

9. A tuned mass damper as defined in claim 8, wherein:
the frame extends around the damper mass; and
the plurality of bumpers are attached inside the frame.

10. A tuned mass damper as defined in claim 8, wherein:
the frame comprises a base member and a post connecting the base member with the conductor plate; and
the plurality of bumpers are mounted on posts extending from the base member and adjacent to the single elongated flexure.

11. A tuned mass damper as defined in claim 8, wherein:
the frame comprises a base member and a post connecting the base member with the conductor plate; and
the plurality of bumpers comprise leaf springs extending from the base member and adjacent to the single elongated flexure.

12. A; tuned mass damper for attenuating vibration of a mechanical structure in a selected plane, the damper comprising:
a frame for attachment to a vibrating mass;
a movable damper mass;
flexure means for connecting the moving damper mass to the frame to confine movement of the damper mass substantially to a selected plane;
a magnet structure forming part of the damper mass, the magnetic structure comprising at least two magnetic poles and arranged to generate a magnetic field across a gap in the magnet structure; and
a conductor plate attached to the frame and positioned for free movement in the selected plane within the gap in the magnet structure;
wherein vibration of the frame is transferred to the damper mass through the flexure means, and is attenuated by generation of eddy currents and a resultant damping force in the conductor plate
and wherein the flexure means comprises a plurality of L-shaped flexures in a co-planar configuration, each connecting the frame to the damper mass and each having stiffness properties that are substantially identical in orthogonal directions in the co-planar configuration.

13. A tuned mass damper as defined in claim 12, and further comprising:
means for limiting movement of the damper mass within the frame.

14. A tuned mass damper as defined in claim 13, wherein:
the means for limiting movement of the damper mass comprises a plurality of snubber assemblies, each comprising a solid pin attached to a selected one of the frame and the damper mass, and a bushing with a resilient lining attached to the other of the frame and the damper mass, wherein the pin is free to move laterally within its corresponding bushing, until contacting the resilient lining.
